(19) United States
(12) Patent Application Publication
(10) Pub. No.: US 2003/0185531 A1
(43) Pub. Date: Oct. 2, 2003

(54) High order mode dispersion compensating fiber

(76) Inventors: Michael Lysiansky, Ramat Gan (IL); David Menashe, Kiryat Ono (IL)

Correspondence Address: LASERCOMM, INC. C/O SHERWOOD PARTNERS, 1849 SAWTELLE BLVD, SUITE 543, LOS ANGELES, CA, 90025, US

(21) Appl. No.: 10/338,865

(22) Filed: Jan. 9, 2003

Related U.S. Application Data
(60) Provisional application No. 60/367,264, filed on Mar. 26, 2002.

(51) Int. Cl. G02B 6/22; G02B 6/16

(52) U.S. Cl. 385/127; 385/123

(57) ABSTRACT

A limited mode dispersion compensating optical fiber supporting at least one high order spatial mode comprising a plurality of core areas. The refractive index profile of the fiber are selected to result in an optical waveguide providing in the LP₀₂ mode dispersion more negative than −300 ps/nm/km at a representative wavelength within an operative waveband, a projected zero dispersion (PZD) less more than 75 nm less than the representative wavelength and third order dispersion less than 2% over the operative waveband. Third order dispersion is defined as the maximum deviation from a best line fit for dispersion divided the best fit dispersion at the representative wavelength, with the best fit line being chosen to minimize the maximum deviation. In one embodiment the PZD lies between 1340 nm and 1420 nm, and in another embodiment the PZD lies between 1420 nm and 1475 nm.

### CROSS-REFERENCE TO RELATED APPLICATIONS

The present application claims the benefit of the filing date of co-pending U.S. provisional application Ser. No. 60/367,264 filed Mar. 26, 2002 entitled “HIGH ORDER MODE DISPERSION COMPENSATING FIBER” and incorporates by reference co-pending U.S. patent application Ser. No. 10/298,548 filed Nov. 18, 2002 entitled “IMPROVED PROFILE FOR LIMITED MODE FIBER”.

### FIELD OF THE INVENTION

The invention relates generally to optical fibers used in optical communication systems and in particular to high order mode dispersion compensating optical fibers.

### BACKGROUND OF THE INVENTION

Optical fiber has become increasingly important in many applications involving the transmission of light. When light is transmitted through an optical fiber, the energy follows a number of paths that are called modes. A mode is a spatially invariant electric field distribution along the length of the fiber. The fundamental mode, also known as the LP₀₁ mode, is the mode in which light passes substantially along the fiber axis. Modes other than the LP₀₁ mode, are known as high order modes. Fibers that have been designed to support only one mode with minimal loss, the LP₀₁ mode, are known as single mode fibers. A multi-mode fiber is a fiber whose design supports multiple modes, and typically supports over 100 modes. A limited mode fiber is a fiber designed to support only a very limited number of modes. For the purpose of this patent, we will define a limited mode fiber as a fiber supporting no more than 20 modes at the operating wavelength band. Fibers may carry different numbers of modes at different wavelengths, however in telecommunications the typical wavelengths are near 1310 nm and 1550 nm, with the C-Band being defined as approximately 1525 nm-1565 nm, and the L-Band being defined as approximately 1565-1610 nm.

As light traverses the optical fiber, different groups of wavelengths travel at different speeds depending on their wavelength, which leads to chromatic dispersion. Chromatic dispersion is defined as the differential of the group velocity in relation to the wavelength in units of picosecond/nanometer (ps/nm). In optical fibers the dispersion experienced by each wavelength of light is a combination of the material dispersion, and the dispersion created by the actual profile of the waveguide, known as waveguide dispersion. Total dispersion is defined as the algebraic sum of waveguide dispersion and material dispersion. In this patent, dispersion refers to the total chromatic dispersion. The units of dispersion are in picoseconds/nanometer (ps/nm), and a waveguide fiber may be characterized by the amount of dispersion per unit length of 1 kilometer, in units of ps/nm/km.

The differential of the dispersion in relation to wavelength is known as the slope, or second order dispersion, and is expressed in units of picoseconds/nanometer² (ps/nm²). Optical fibers may be further characterized by their slope per unit length of 1 kilometer, which is expressed in units of ps/nm²/km. For a fiber exhibiting non-linear dispersion over the operative range, a best-fit line of the dispersion characteristic is utilized, the best-fit line being selected to minimize the absolute value of the maximum deviation between the actual dispersion curve and the best-fit line over the operative wavelength range. For the purposes of this patent, the slope at a representative wavelength λ₀ of the operating wavelength range is defined as the slope of the best-fit line over that range. The dispersion at λ₀ is defined as the dispersion of the best-fit line at the representative wavelength.

For the “C” band, which is conventionally defined as the wavelength range from 1525 nm to 1565 nm, the representative wavelength used is 1550 nm. For the “L” band, which may include wavelengths from 1565 nm to 1620 nm, the representative wavelength used is 1590 nm.

Transmission fibers typically exhibit a nearly linear dispersion curve, and thus exhibit nearly uniform positive slope as a function of wavelength. Any mismatch between the combination of dispersion and slope exhibited by the transmission media and the dispersion-compensating device will result in residual dispersion. Furthermore, any deviation from a linear dispersion curve by the dispersion-compensating device, will also contribute to residual dispersion. For the purpose of this patent, the maximum deviation δD from the linear fit is called third order dispersion (hereinafter “TOD”), as it is a result of a non-uniform second order dispersion, and is described as a percentage of the dispersion at λ₀, TOD=100*δD/D(λ₀).

Projected zero dispersion (hereinafter “PZD”) is defined as

$${λ}_{0} - \frac{D ( {λ}_{0} )}{Slope ( {λ}_{0} )} .$$

A dispersion compensating fiber should ideally have the same PZD as the transmission fiber that it compensates. Small corrections to compensate for the differential between the PZD of the transmission fiber and the compensating fiber may be corrected by use of a trim fiber, as described in U.S. Pat. No. 6,339,665 whose contents are incorporated herewith by reference.

Certain transmission fibers, notably single mode transmission fiber exhibiting zero dispersion at approximately 1330 nm (hereinafter “SMTF”), have a PZD when operated at around 1550 nm of approximately 1260 nm. Conventional non-zero dispersion shifted fibers (hereinafter “conventional NZDSF”) have their PZD at around 1490 nm to 1515 nm, while other transmission fibers (hereinafter “low PZD NZDSF”) have a PZD varying between 1400 nm and 1460 nm.

Single mode fibers designed as dispersion compensating fibers (hereinafter “DCF”) are well known in the art, and typically exhibit dispersion on the order of −80 ps/nm/km. Unfortunately, single mode DCF exhibits a small effective area (A_{eff}) which limits the amount of power which may traverse the fiber without experiencing non-linear effects. New fibers that operate in the fundamental mode and compensate for both dispersion and slope have been recently marketed, however these suffer from an even smaller A_{eff}. Overall, DCF's are designed to introduce negative dispersion with zero or negative dispersion slope, in order to achieve broad dispersion compensation of the associated transmission fiber.

Few mode fibers designed to have specific characteristics in a mode other than the fundamental mode are also known as high order mode (HOM) fibers. The operative high order mode is also known as the desired mode. HOM fibers are particularly useful for compensating chromatic dispersion due to the large amount of negative dispersion that can be experienced by a signal traversing certain fibers in a high order mode. Additionally, HOM fibers may exhibit negative slope, opposite to the positive slope of most transmission fibers. Furthermore HOM fibers, in particularly those operating in the LP₀₂ mode, exhibit a larger effective area than corresponding DCFs based on the fundamental mode due to the larger mode field diameter of the LP₀₂ mode. A large effective area is indicative of low non-linear effects in the face of higher power transmission.

In HOM fibers the light in each mode travels at its own velocity, thus light traveling in different modes may interfere with each other at the detector. This is known as multi-path interference or MPI. Very efficient mode transformers, such as a transverse mode transformer of the type described in U.S. Pat. No. 6,404,951 are advantageously utilized to launch light almost exclusively in the desired mode, thus minimizing the amount of light traveling in modes other than the desired mode.

Fiber profiles designed to allow propagation of specific high order modes while functioning primarily in the fundamental mode exist. U.S. Pat. No. 5,448,674 discloses a limited mode fiber with a refractive index profile selected such that the fiber supports the LP₀₁ and LP₀₂ modes but does not support the LP₁₁ mode. At λ₀, LP₀₁ has dispersion more negative than −150 ps/nm/km, and slope is negative.

U.S. Pat. No. 5,802,234 discloses an HOM fiber exhibiting dispersion substantially in the LP₀₂ mode. The mode exhibits negative dispersion more negative than −200 ps/nm/km at a representative wavelength of 1550 nm, and exhibits TOD of approximately 2.50%. Thus for a length of HOM fiber chosen to compensate for 1,000 ps/nm of dispersion, and its accompanying slope, a residual dispersion of up to 25 ps/nm at certain wavelengths will be uncompensated. Such a residual dispersion is problematic for high speed optical networks. The patent further discloses a prior art HOM fiber comprising a single zone, exhibiting high dispersion and a sharp cutoff near the operative wavelength. Such a profile exhibits an even larger TOD of approximately 4.2%.

U.S. Pat. No. 6,442,320 assigned to the current assignee of this application describes an HOM fiber exhibiting negative dispersion, negative dispersion slope and negative or zero third order dispersion in the LP₀₂ mode substantially over the operative wavelength range. The dispersion of the fibers in the LP₀₂ mode at a λ₀ of 1550 nm exhibit a TOD greater than 3%, and a PZD of approximately 1490-1495 nm. Such a PZD is not ideally suited for compensation of SMTF or for low PZD NZDSF.

U.S. Pat. No. 6,453,102 discloses a number of profiles having a plurality of core segments exhibiting dispersion in the LP₀₂ mode in a waveband centered around 1550 nm. A number of profiles exhibit dispersion whose absolute value does not exceed 200 ps/nm/km at a λ₀ of 1550 nm, and thus require a longer length of fiber to compensate a transmission link than compensating fibers exhibiting higher dispersion. Long lengths of HOM fiber experience high loss and greater MPI than is desirable. Two profiles exhibit dispersion in the LP₀₂ mode whose dispersion at a λ₀ of 1550 nm is more negative than −300 ps/nm/km, thus being suitable for use to compensate a typical transmission link. One profile exhibits a dispersion of −490 ps/nm/km at 1550 nm, with a kappa, defined as dispersion/slope at 1550, of 58 nm. The PZD of such a fiber is thus 1492 nm, which is not suitable for compensating for SMTF or for low PZD. A second profile exhibits a dispersion of −941 ps/nm/km with a kappa of 34. The PZD of such a fiber is thus 1516 nm, which is similarly unsuitable for compensating for SMTF or for low PZD NZDSF. Furthermore the TOD of this second profile is over 4%.

There is therefore a need for an HOM fiber exhibiting dispersion more negative than −300 ps/nm/km at λ₀, a PZD at least 75 nm less than λ₀, and a TOD of no more than 2%.

### DEFINITIONS

n(r) is the refractive index profile as a function of radius along a waveguide fiber. The refractive index is given at a wavelength of 1550 nm.

N_{eff} is defined as the effective refractive index of the mode.

Δ is defined in the conventional matter, namely Δ(r)=(n(r)−n₀)/n₀, where n₀ is the refractive index of pure vitreous SiO₂ at the operative wavelength of 1550 nm, which is approximately 1.444.

The radii of the regions of the core are defined in terms of the index of refraction. A particular region begins at the point where the refractive index characteristic of that region begins, and a particular region ends at the last point where the refractive index is characteristic of that particular region. In general, we will use the point of return to the refractive index of the cladding to define the border between two adjacent regions that cross the cladding index. Radius will have this definition unless otherwise noted in the text.

λ₀ is the representative wavelength. For the “C” band λ₀ is chosen as 1550 nm, and for the “L” band λ₀ is chosen as 1590 nm. Other values for λ₀ may be utilized without exceeding the scope of the invention.

A best-fit line for dispersion is calculated for a fiber exhibiting non-linear dispersion over the operative waveband. The best-fit line is a straight line calculated to minimize the absolute value of the maximum deviation between the actual dispersion curve and the best-fit line over the operatuve waveband. The slope at λ₀ is defined as the slope of the best-fit line over the operative wavelength range. The dispersion at λ₀ is defined as the dispersion of the best-fit line at λ₀.

Third order dispersion (TOD) is the maximum deviation δD between the actual dispersion and the best-fit line over the operating waveband, and is calculated as a percentage of the dispersion at λ₀. TOD=100*δD/D(λ₀)

Projected zero dispersion (PZD) is defined as

$${λ}_{0} - \frac{D ( {λ}_{0} )}{Slope ( {λ}_{0} )} .$$

The slope and dispersion at λ₀ is utilized to arrive at the PZD.

### SUMMARY OF THE INVENTION

Accordingly, it is a principal object of the present invention to overcome the disadvantages of prior art. This is provided in the present invention by a limited mode dispersion compensating optical fiber supporting at least one high order spatial mode, comprising a plurality of core areas, the refractive index profile of which are selected to result in an optical waveguide providing in the LP₀₂ mode; dispersion more negative than −300 ps/nm/km at a representative wavelength, designated λ₀, within an operative waveband; projected zero dispersion less than (λ₀−75 nm), where projected zero dispersion is defined as λ₀−Dispersion (_{λ0})/Slope(_{λ0}); and third order dispersion less than 2% over the operative waveband, where third order dispersion is defined as the maximum deviation from a best line fit for dispersion divided the best fit dispersion at λ₀, the best fit line being chosen to minimize the maximum deviation.

In a preferred embodiment the plurality of core segments of the limited mode dispersion compensating optical fiber further comprise: a first core area having a peak refractive index nc₁; a second core area contactingly surrounding the first core area having a peak refractive index nc₂; a third core area contactingly surrounding the second core area having a peak refractive index nc₃; and a cladding area surrounding the third core area having a refractive index n_{clad}; wherein the peak refractive index nc₁ is greater than nc₂, nc₃ and nc_{clad} and the peak refractive index nc₃ is greater than nc_{clad}.

In one further preferred embodiment the peak refractive index nc₂ is less than the refractive index nc_{clad}, and in another further preferred embodiment the difference between the first core peak refractive index, nc₁, and the cladding area refractive index, nc_{clad}, divided by nc_{clad} is less than about 2.8%. In another further preferred embodiment the difference between the first core peak refractive index, nc₁, and the cladding area refractive index nc_{clad}, divided by nc_{clad} is less than about 2.2%. In yet another further preferred embodiment the difference between the second core peak refractive index, nc₂, and the cladding area refractive index nc_{clad}, divided by nc_{clad} is more positive than about −0.42%. In another further preferred embodiment the ratio of the difference between the first core area peak refractive index nc₁, and the cladding refractive index nc_{clad}, divided by nc_{clad} is approximately 2.22% and the first cladding area exhibits a nominal radius of between 3.98 microns and 4.07 microns; the ratio of the difference between the second core area peak refractive index nc₂, and the cladding refractive index nc_{clad}, divided by nc_{clad} is between −0.37% and −0.42% and the second cladding area exhibits a nominal radial width of between 2.00 microns and 2.26 microns; and the ratio of the difference between the third core area peak refractive index nc₃, and the cladding refractive index nc_{clad}, divided by nc_{clad} is between 0.38% and 0.45% and the third cladding area exhibits a nominal radial width of between 2.34 and 2.65 microns.

In another preferred embodiment dispersion is more negative than −400 ps/nm/km at the representative wavelength, while in another preferred embodiment the plurality of core areas further provides for an effective area in the LP₀₂ mode greater than 50 micron² at the representative wavelength.

In another preferred embodiment the representative wavelength is 1550 nm, and in a further preferred embodiment the operative waveband comprises 1535 nm to 1555 nm.

In yet another preferred embodiment the representative wavelength is 1590 nm, and in a further preferred embodiment the operative waveband comprises 1575 nm to 1605 nm.

The invention also provides for an optical communication system comprising: an optical transmission fiber exhibiting positive dispersion and positive dispersion slope; a limited mode dispersion compensating optical fiber in optical serial communication with said optical transmission fiber, said limited mode dispersion compensating optical waveguide supporting the LP₀₂ mode; and a mode transformer in optical communication with said limited mode dispersion compensating optical fiber; wherein said limited mode dispersion compensating optical fiber exhibits a plurality of core areas, the refractive index profile of which are selected to result in an optical waveguide providing in the LP₀₂ mode: dispersion more negative than −300 ps/nm/km at a representative wavelength, designated λ₀, within an operative waveband; projected zero dispersion less than (λ₀−75 nm), where projected zero dispersion is defined as λ₀−Dispersion (_{λ0})/Slope(_{λ0}); and third order dispersion less than 2% over the operative waveband, where third order dispersion is defined as the maximum deviation from a best line fit for dispersion divided the best fit dispersion at λ₀, said best fit line chosen to minimize said maximum deviation.

In one preferred embodiment the optical transmission fiber is a single mode fiber exhibiting zero dispersion at approximately 1330 nm, in another preferred embodiment the optical transmission fiber is characterized by a projected zero dispersion between 1340 nm and 1420 nm, and in yet another preferred embodiment the optical transmission fiber is characterized by a projected zero dispersion between 1420 nm and 1475 nm.

In another preferred embodiment the plurality of core segments of the limited mode dispersion compensating optical fiber further comprise: a first core area having a peak refractive index nc₁; a second core area contactingly surrounding the first core area having a peak refractive index nc₂; a third core area contactingly surrounding the second core area having a peak refractive index nc₃; and a cladding area surrounding the third core area having a refractive index n_{clad}; wherein the peak refractive index nc₁ is greater than nc₂, nc₃ and nc_{clad} and the peak refractive index nc₃ is greater than nc_{clad}.

In one further preferred embodiment the difference between the first core peak refractive index, nc₁, and the cladding area refractive index, nc_{clad}, divided by nc_{clad} is less than about 2.8%. In another further preferred embodiment the difference between the second core peak refractive index, nc₂, and the cladding area refractive index, nc_{clad}, divided by nc_{clad} is more positive than about −0.42%

Additional features and advantages of the invention will become apparent from the following drawings and description.

### BRIEF DESCRIPTION OF THE DRAWINGS

For a better understanding of the invention and to show how the same may be carried into effect, reference will now be made, purely by way of example, to the accompanying drawings.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. In the accompanying drawings:

FIG. 1 depicts a high-level block diagram of a prior art system comprising a dispersion management module;

FIG. 2 depicts a refractive index profile according to a first embodiment of the invention;

FIG. 3 depicts dispersion in the LP₀₂ mode of the refractive index profile of FIG. 2;

FIG. 4 depicts the effective area in the LP₀₂ mode of the refractive index profile of FIG. 2;

FIG. 5 depicts a refractive index profile according to a second embodiment of the invention;

FIG. 6 depicts dispersion in the LP₀₂ mode of the refractive index profile of FIG. 5;

FIG. 7 depicts the effective area in the LP₀₂ mode of the refractive index profile of FIG. 5;

FIG. 8 depicts a refractive index profile according to a third embodiment of the invention;

FIG. 9 depicts actual dispersion in the LP₀₂ mode of the refractive index profile of FIG. 8;

FIG. 10 depicts best-fit dispersion in the LP₀₂ mode of the refractive index profile of FIG. 8;

FIG. 11 depicts the effective area in the LP₀₂ mode of the refractive index profile of FIG. 8;

FIG. 12 depicts a refractive index profile according to a fourth embodiment of the invention;

FIG. 13 depicts dispersion in the LP₀₂ mode of the refractive index profile of FIG. 12;

FIG. 14 depicts the effective area in the LP₀₂ mode of the refractive index profile of FIG. 12;

FIG. 15 depicts a refractive index profile according to a fifth embodiment of the invention;

FIG. 16 depicts dispersion in the LP₀₂ mode of the refractive index profile of FIG. 15;

FIG. 17 depicts the effective area in the LP₀₂ mode of the refractive index profile of FIG. 15;

FIG. 18 depicts a refractive index profile according to a sixth embodiment of the invention;

FIG. 19 depicts dispersion in the LP₀₂ mode of the refractive index profile of FIG. 18; and

FIG. 20 depicts the effective area in the LP₀₂ mode of the refractive index profile of FIG. 18.

### DETAILED DESCRIPTION

The present embodiments enable a high order mode dispersion compensating fiber exhibiting average dispersion more negative than −300 ps/nm/km at a representative wavelength λ₀, PZD more than 75 nm below λ₀, and TOD of 2% or less. Such a fiber is ideally suited for compensation of the dispersion and slope of SMTF which exhibits a PZD of approximately 1260 nm, and for compensation of the dispersion and slope of low PZD NZDSF fibers. In one embodiment the fiber profile is used in combination with a trim fiber exhibiting negative dispersion and positive slope in the fundamental mode.

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

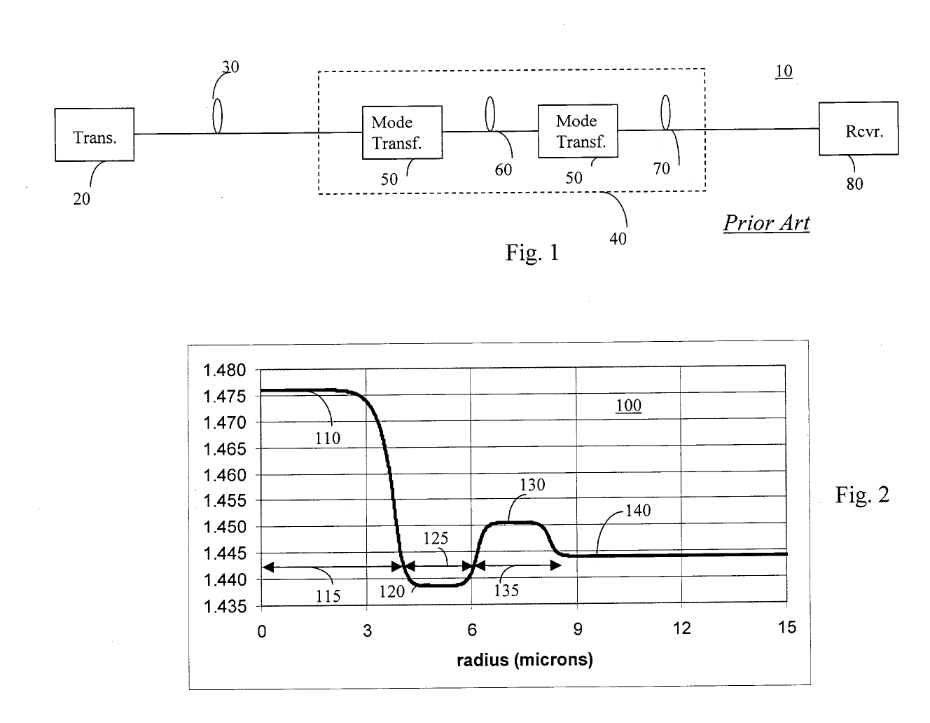

FIG. 1 illustrates a block diagram of a prior art transmission system 10 in accordance with the teachings of U.S. Pat. No. 6,339,665 entitled “Apparatus and Method for Compensation of Chromatic Dispersion in Optical Fibers” and U.S. Pat. No. 6,404,952 entitled “Optical Communication System with Chromatic Dispersion Compensation” whose contents are incorporated herewith by reference, comprising transmitter 20, single mode transmission fiber 30, receiver 80 and dispersion management device 40 comprising mode transformers 50, HOM fiber 60 and optional trim fiber 70. The output of transmitter 20 is connected to a first end of single mode transmission fiber 30, and the second end of transmission fiber 30 is connected to the input of dispersion management device 40. The input of dispersion management device 40 comprises first mode transformer 50, and the second end of transmission fiber 120 is thus optically connected to the input of first mode transformer 50. The output of first mode transformer 50 is connected to one end of HOM fiber 60, and the other end of HOM fiber 60 is connected to the input of second mode transformer 50. The output of second mode transformer 50 is connected to a first end of optional trim fiber 70 and the second end of optional trim fiber 70 is connected at the output of dispersion management device 40 to the input of receiver 80.

In operation system 10 of FIG. 1 utilizes the dispersion and slope of HOM fiber 60 and optional trim fiber 70 to compensate for dispersion and slope incurred in transmission fiber 30. Transmitter 20 transmits the optical signal into a length of transmission fiber 30, which in an exemplary embodiment comprises SMTF exhibiting dispersion at 1550 nm of 17 ps/nm/km, with a slope of 0.057 ps/nm²/km. In an exemplary embodiment the length of transmission fiber 30 is 80 kilometers prior to the signal requiring amplification or reconversion to an electrical signal, and the signal experiences 1,360 ps/nm of total dispersion and a slope of 4.56 ps/nm² at 1550 nm. In another embodiment (not shown) receiver 80 is replaced with an optical amplifier. In still another embodiment (not shown), the first stage of an optical amplifier is inserted between the second end of transmission fiber 30 and the input of dispersion management device 40.

The output of transmission fiber 30, optionally having been amplified, is optically coupled to first mode transformer 50, which operates to convert the optical signal from the fundamental mode to the single high order mode supported by HOM fiber 60, which in an exemplary embodiment is the LP₀₂ mode. Mode transformers 50 in an exemplary embodiment are of the type described in U.S. Pat. No. 6,404,951 entitled “Transverse Spatial Mode Transformer for Optical Communication” whose contents are incorporated herein by reference. In another embodiment a longitudinal mode transformer is utilized. It is to be noted that first mode transformer 50 is the input stage of dispersion management device 40, which in a preferred embodiment is designed to fully compensate for both the dispersion and slope of transmission fiber 30.

The output of first mode transformer 50, is optically coupled to a one end of a length of HOM fiber 60, which acts to compensate for the dispersion and slope imparted by transmission fiber 30. In a preferred embodiment, HOM fiber 60 does not complete the compensation, as the PZD of HOM fiber 60 does not match that of transmission fiber 30. The second end of HOM fiber 60 is connected to input of second mode transformer 50 that transforms the signal from the operative high order mode to the fundamental mode, and outputs the signal to one end of optional trim fiber 70. Optional trim fiber 70 comprises a length of fiber with dispersion and slope characteristics designed to complete the compensation. In one embodiment optional trim fiber 70 comprises an appropriate length of dispersion compensating fiber, and in another embodiment optional trim fiber 70 comprises a length of NZDSF. Other trim fibers, including a trim fiber specifically designed to have the desired dispersion and slope characteristics in the fundamental mode may be utilized. The second end of trim fiber 70 is connected through the output of dispersion management device 40 to receiver 80. In another embodiment complete dispersion and/or slope compensation is not required, and the device is designed to compensate for a specified fraction of the dispersion and/or slope of the transmission fiber. In yet another embodiment the PZD of HOM fiber 60 matches that of transmission fiber 30, and optional trim fiber 70 is not utilized. In this latter embodiment, the output of second mode transformer 50 is connected through the output of dispersion management device 40 to receiver 80.

FIG. 2 illustrates a profile 100 of a fiber designed to have negative dispersion, a PZD of approximately 1406 nm a TOD of approximately 1.1% at a representative wavelength λ₀ of 1550 nm in accordance with a first embodiment of the subject invention. The x-axis represents fiber radius and the y-axis represents refractive index of the fiber at the operative wavelength of 1550 nm. Fiber profile 100 comprises first core area 110 exhibiting radius 115, adjacent second core area 120 exhibiting width 125, adjacent third core area 130 exhibiting width 135 and adjacent cladding area 140. First core area 110 has a general shape wherein the refractive index varies over the radius 115 with a peak refractive index of 1.4760 corresponding to Δ₁ of 2.22%, and a radius of approximately 3.99 microns. Second core area 120 has a general shape exhibiting a depressed index of approximately 1.4386 corresponding to Δ₂ of −0.37%, with a width 125 of approximately 2.16 microns. Third core area 130 exhibits a general shape with an increased refractive index of approximately 1.4505 corresponding to Δ₃ of 0.45%. Third core area 130 covers a width 135 of approximately 2.34 microns. Cladding area 140 extends the balance of the radius of the fiber as is known to those skilled in the art. In an exemplary embodiment total fiber radius is approximately 125 microns, however other fiber radii may be utilized without exceeding the scope of the invention.

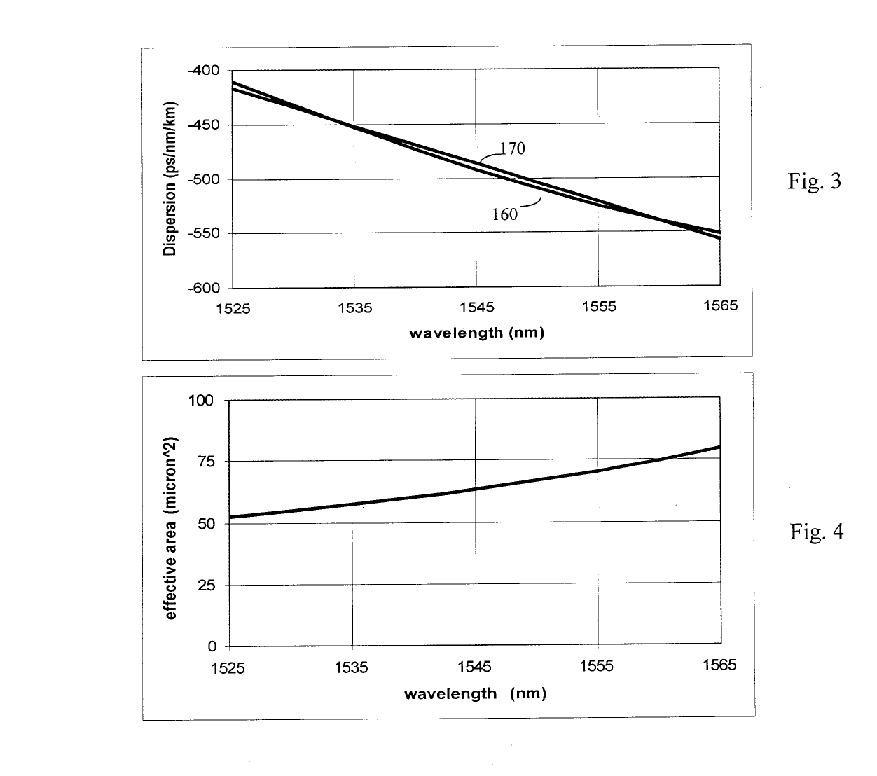

FIG. 3 illustrates a plot 160 of the dispersion of the LP₀₂ mode for the few mode fiber profile 100 of FIG. 2 over the operative “C” waveband and straight line 170 representing the best-fit line for dispersion plot 160, which is calculated to minimize the maximal difference between the best fit line 170 and actual dispersion plot 160. The x-axis representing wavelength and the y-axis represents dispersion in ps/nm/km. Plot 160 exhibits negative dispersion that is wavelength dependent, with dispersion at 1525 nm being approximately −411 ps/nm/km, dispersion at 1550 nm being approximately −510 ps/nm/km and dispersion at 1565 nm being approximately −551 ps/nm/km. Best-fit line 170 exhibits dispersion at λ₀ of 1550 nm of approximately −504 ps/nm/km and a slope of −3.50 ps/nm²/km with a resultant PZD of 1406 nm. Such a PZD is ideal for compensation of certain low PZD NZDSF exhibiting approximately 8 ps/nm/km of dispersion and 0.057 ps/nm²/km slope at 1550 nm. The PZD of such a transmission fiber is calculated to be approximately 1410 nm, and thus the overcompensation is easily trimmed with conventional SMTF. Additionally, conventional SMTF exhibiting a PZD of approximately 1260 nm can be advantageously compensated using an appropriate trim fiber. The maximum difference between the best fit line 170 and the dispersion plot 160 is approximately 5.5 ps/nm and therefore the TOD is approximately 1.1%.

FIG. 4 illustrates a plot of the effective area of profile 100 of FIG. 2 for the LP₀₂ mode, with the x-axis representing wavelength in nanometers and the y-axis representing effective area microns². The effective area is approximately 52 micron² at 1525 nm, 67 micron² at 1550 nm and 80 micron² at 1565 nm.

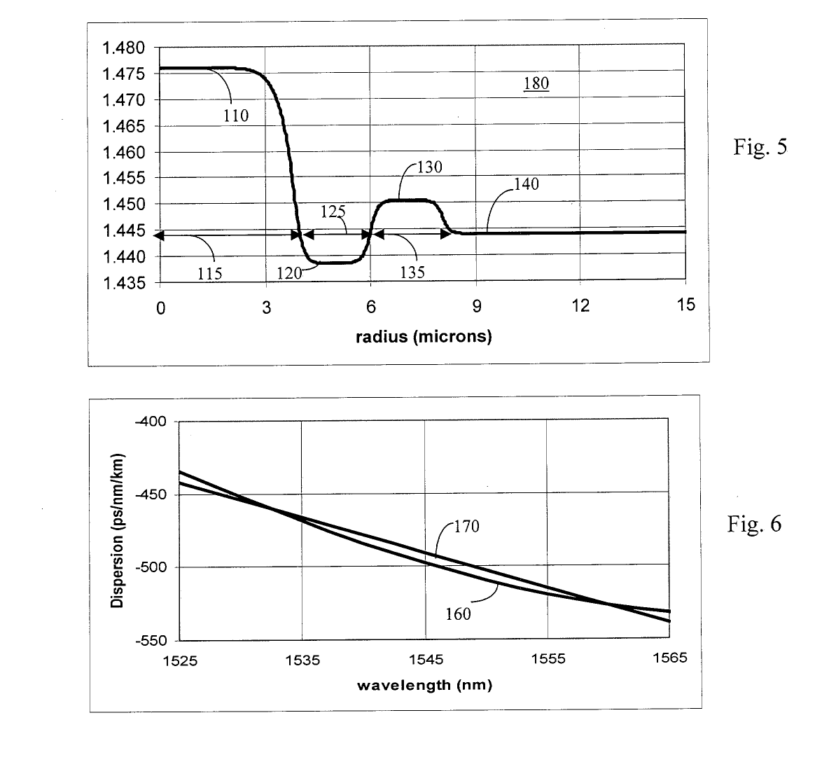

FIG. 5 illustrates a profile 180 of a fiber designed to have negative dispersion, a PZD of approximately 1343 nm a TOD of approximately 1.4% at a representative wavelength λ₀ of 1550 nm in accordance with a second embodiment of the subject invention. The x-axis represents fiber radius and the y-axis represents refractive index of the fiber at the operative wavelength of 1550 nm. Fiber profile 180 comprises first core area 110 exhibiting radius 115, adjacent second core area 120 exhibiting width 125, adjacent third core area 130 exhibiting width 135 and adjacent cladding area 140. First core area 110 has a general shape wherein the refractive index varies over the radius 115 with a peak refractive index of 1.4760 corresponding to Δ₁ of 2.22%, and a radius of approximately 3.98 microns. Second core area 120 has a general shape exhibiting a depressed index of approximately 1.4386 corresponding to Δ₂ of −0.37%, with a width 125 of approximately 2.00 microns. Third core area 130 exhibits a general shape with an increased refractive index of approximately 1.4505 corresponding to Δ₃ of 0.45%. Third core area 130 covers a width 135 of approximately 2.34 microns. Cladding area 140 extends the balance of the radius of the fiber as is known to those skilled in the art. In an exemplary embodiment total fiber radius is approximately 125 microns, however other fiber radii may be utilized without exceeding the scope of the invention. The profile is similar in most respects to profile 100 of FIG. 2, with a slightly reduced width 115 for first core area 110 and a reduced width 125 for second core area 120.

FIG. 6 illustrates plot 160 of the dispersion of the LP₀₂ mode for the few mode fiber profile 180 of FIG. 4 over the operative “C” waveband, and straight line 170 representing the best-fit line for dispersion plot 160, which is calculated to minimize the maximal difference between the best-fit line 170 and actual dispersion plot 160. The x-axis represents wavelength, and the y-axis represents dispersion in ps/nm/km. Plot 160 exhibits negative dispersion that is wavelength dependent, with dispersion at 1525 nm being approximately −435 ps/nm/km, dispersion at 1550 nm being approximately −509 ps/nm/km and dispersion at 1565 nm being approximately −532 ps/nm/km. Best-fit line 170 exhibits dispersion at λ₀ of 1550 nm of approximately −503 ps/nm/km and a slope of −2.43 ps/nm²/km with a resultant PZD of 1343 nm, which is approximately 70 nm lower than that of profile 100 of FIG. 2. Such a PZD is close to that of conventional SMTF exhibiting a PZD of approximately 1260 nm, and can be advantageously utilized with an appropriate trim fiber. Furthermore, the fiber may be utilized with certain low PZD NZDSF. The maximum difference between the best fit line 170 and the dispersion plot 160 is approximately 7 ps/nm and therefore the TOD is approximately 1.4%, which is slightly higher than the TOD exhibited by profile 100 of FIG. 2.

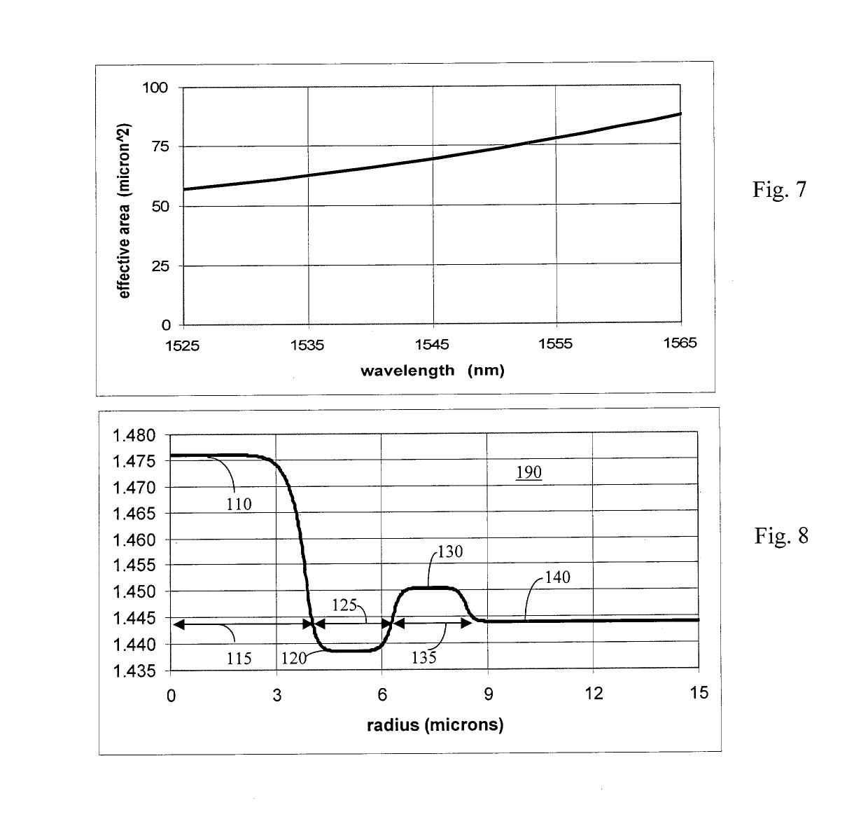

FIG. 7 illustrates a plot of the effective area of profile 180 of FIG. 5 for the LP₀₂ mode, with the x-axis representing wavelength in nanometers and the y-axis representing effective area microns². The effective area is approximately 57 micron² at 1525 nm, 73 micron² at 1550 nm and 88 micron² at 1565 nm.

FIG. 8 illustrates a profile 190 of a fiber designed to have negative dispersion, a PZD of approximately 1438 nm a TOD of approximately 0.63% at a representative wavelength λ₀ of 1550 nm in accordance with a third embodiment of the subject invention. The x-axis represents fiber radius and the y-axis represents refractive index of the fiber at the operative wavelength of 1550 nm. Fiber profile 190 comprises first core area 110 exhibiting radius 115, adjacent second core area 120 exhibiting width 125, adjacent third core area 130 exhibiting width 135 and adjacent cladding area 140. First core area 110 has a general shape wherein the refractive index varies over the radius 115 with a peak refractive index of 1.4760 corresponding to Δ₁ of 2.22%, and a radius of approximately 4.02 microns. Second core area 120 has a general shape exhibiting a depressed index of approximately 1.4386 corresponding to Δ₂ of −0.37%, with a width 125 of approximately 2.26 microns. Third core area 130 exhibits a general shape with an increased refractive index of approximately 1.4505 corresponding to Δ₃ of 0.45%. Third core area 130 covers a width 135 of approximately 2.34 microns. Cladding area 140 extends the balance of the radius of the fiber as is known to those skilled in the art. In an exemplary embodiment total fiber radius is approximately 125 microns, however other fiber radii may be utilized without exceeding the scope of the invention. The profile is similar in most respects to profile 100 of FIG. 2, with a slightly increased width 115 for first core area 110, an increased width 125 for second core area 120.

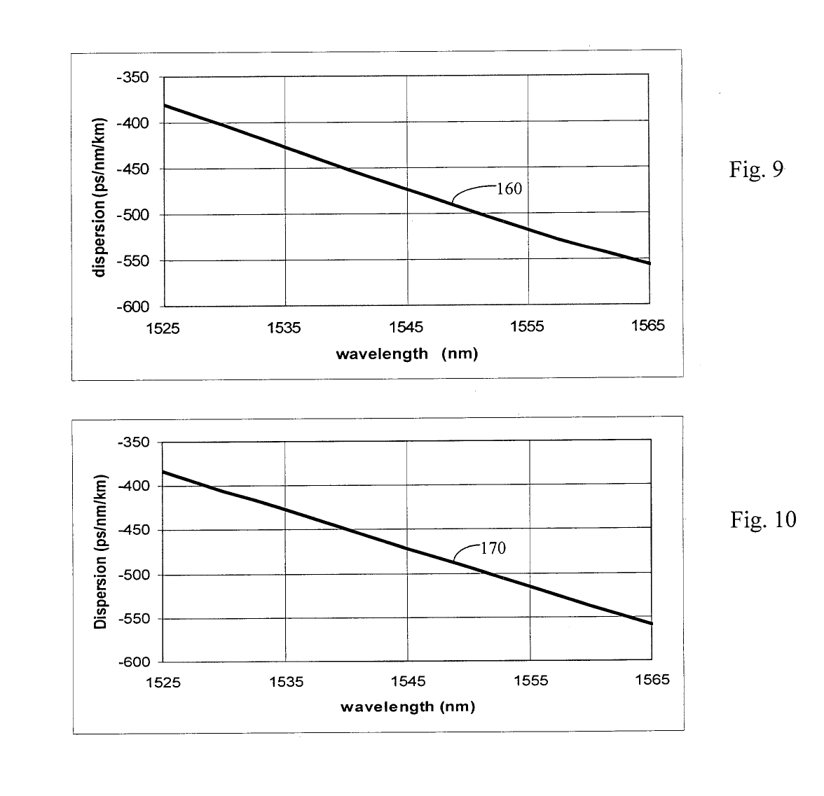

FIG. 9 illustrates plot 160 of the dispersion in the LP₀₂ mode for the few mode fiber profile 190 of FIG. 8 over the operative “C” waveband, with the x-axis representing wavelength, and the y-axis representing dispersion in ps/nm/km. The fiber exhibits negative dispersion that is wavelength dependent, with dispersion at 1525 nm being approximately −381 ps/nm/km, dispersion at 1550 nm being approximately −497 ps/nm/km and dispersion at 1565 nm being approximately −556 ps/nm/km.

FIG. 10 illustrates the best-fit line 170 for dispersion, which is calculated to minimize the maximal difference between the best-fit line 170 and actual dispersion plot 160 of FIG. 9. Line 170 is displayed separately from plot 160 for clarity. Best-fit line 170 exhibits dispersion of approximately −494 ps/nm/km at λ₀ of 1550 nm and a slope of −4.4 ps/nm²/km with a resultant PZD of approximately 1438 nm. Such a PZD is in the range of low PZD NZDSF, and may be used in combination with an appropriate trim fiber. The maximum difference between the best fit line 170 of FIG. 10 and the dispersion plot 160 of FIG. 9 is approximately 3 ps/nm and therefore the TOD is approximately 0.63%, which is lower than that of profile 100 of FIG. 2.

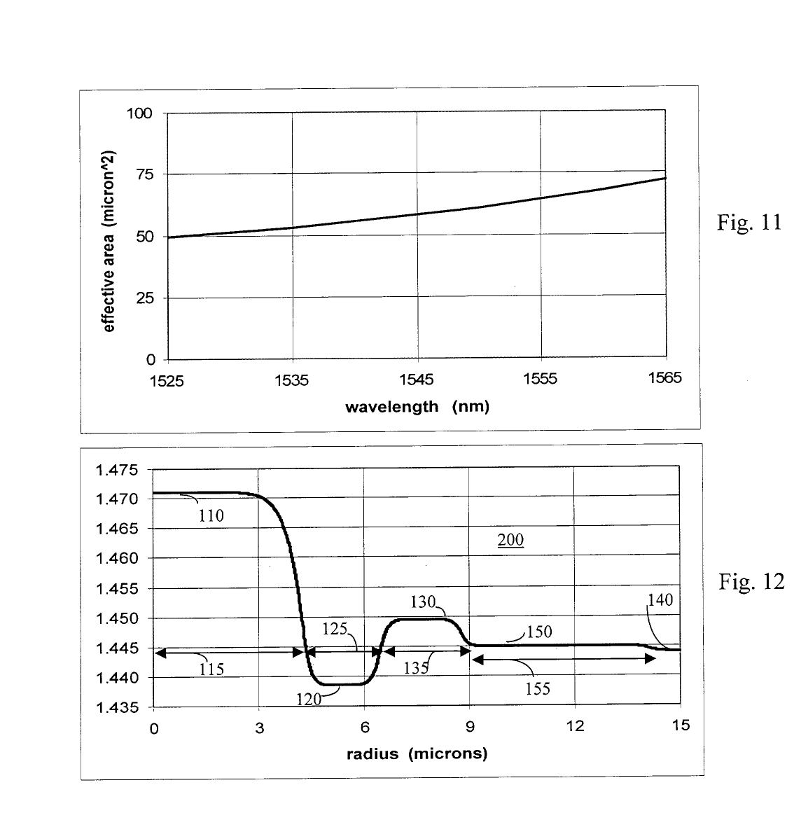

FIG. 11 illustrates a plot of the effective area of profile 190 of FIG. 8 for the LP₀₂ mode, with the x-axis representing wavelength in nanometers and the y-axis representing effective area microns². The effective area is approximately 49 micron² at 1525 nm, 61 micron² at 1550 nm and 72 micron² at 1565 nm.

FIG. 12 illustrates a profile 200 of a fiber designed to have negative dispersion, a PZD of approximately 1372 nm a TOD of approximately 1.8% at a representative wavelength λ₀ of 1550 nm in accordance with a fourth embodiment of the subject invention. The profile exhibits a lower Δ₁ than that of the previous embodiments, which results in reduced MPI due to a lower coupling coefficient between the modes. The x-axis represents fiber radius and the y-axis represents refractive index of the fiber at the operative wavelength of 1550 nm. Fiber profile 200 comprises first core area 110 exhibiting radius 115, adjacent second core area 120 exhibiting width 125, adjacent third core area 130 exhibiting width 135, adjacent fourth core area 150 exhibiting width 155, and adjacent cladding area 140. First core area 110 has a general shape wherein the refractive index varies over the radius 115 with a peak refractive index of 1.4710 corresponding to Δ₁ of 1.87%, and a radius of approximately 4.35 microns. Second core area 120 has a general shape exhibiting a depressed index of approximately 1.4385 corresponding to Δ₂ of −0.38%, with a width 125 of approximately 2.12 microns. Third core area 130 exhibits a general shape with an increased refractive index of approximately 1.4495 corresponding to Δ₃ of 0.38%. Third core area 130 covers a width 135 of approximately 2.69 microns. Fourth core area 180 exhibits a general shape with an increased refractive index of approximately 1.4449 corresponding to Δ₄ of 0.06%. Fourth core area 180 covers a width 185 of approximately 5.44 microns. Cladding area 140 extends the balance of the radius of the fiber as is known to those skilled in the art. In an exemplary embodiment total fiber radius is approximately 125 microns, however other fiber radii may be utilized without exceeding the scope of the invention. The profile has a lower peak refractive index than profile 100 of FIG. 2, and the addition of fourth core area 180. The lower peak refractive index reduces the coupling between modes thus resulting in a lower MPI per unit length of HOM fiber. Other advantages of profile 200 are described in co-pending U.S. patent application Ser. No. 10/298,548 filed Nov. 18, 2002 entitled “IMPROVED PROFILE FOR LIMITED MODE FIBER” whose contents are incorporated herein by reference.

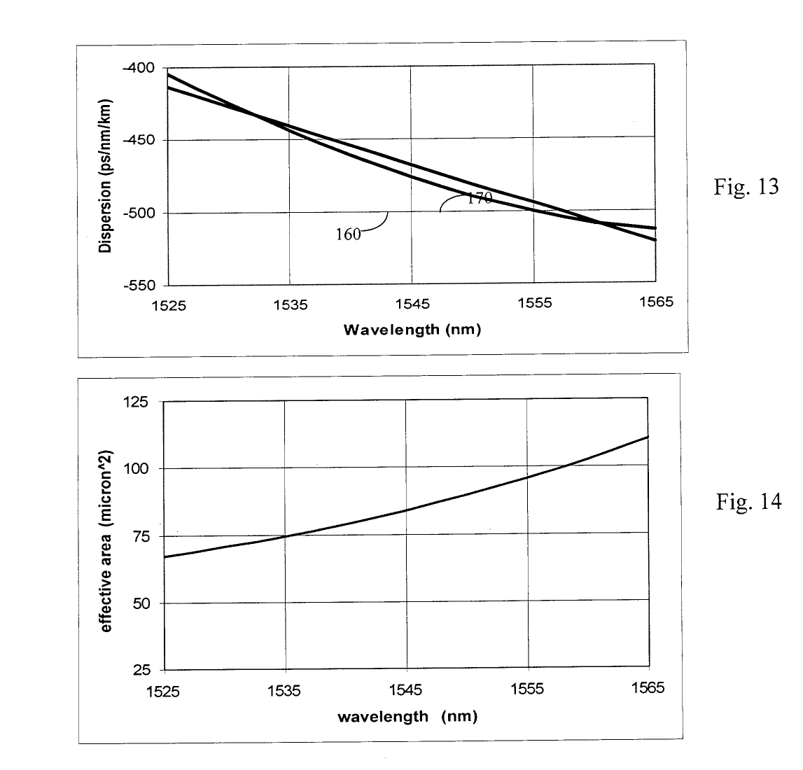

FIG. 13 illustrates plot 160 of the dispersion of the LP₀₂ mode for the few mode fiber profile 200 of FIG. 12 over the operative “C” waveband, and straight line 170 representing the best-fit line for dispersion plot 160, which is calculated to minimize the maximal difference between the best-fit line 170 and actual dispersion plot 160. The x-axis represents wavelength, and the y-axis represents dispersion in ps/nm/km. Plot 160 exhibits negative dispersion that is wavelength dependent, with dispersion at 1525 nm being approximately −405 ps/nm/km, dispersion at 1550 nm being approximately −490 ps/nm/km and dispersion at 1565 nm being approximately −513 ps/nm/km. Best-fit line 170 exhibits dispersion at λ₀ of 1550 nm of approximately −481 ps/nm/km and a slope of −2.7 ps/nm²/km, and therefore a PZD of 1372 nm. Such a PZD is advantageous for compensating for conventional SMTF in combination with an appropriate trim fiber, and for certain low PZD NZDSF that exhibit PZD of approximately 1350 nm. The maximum difference between the best fit line 170 and dispersion plot 160 is approximately 9 ps/nm and therefore the TOD is approximately 1.8%.

FIG. 14 illustrates a plot of the effective area of profile 200 of FIG. 12 for the LP₀₂ mode, with the x-axis representing wavelength in nanometers and the y-axis representing effective area microns². The effective area is approximately 67 micron² at 1525 nm, 89 micron² at 1550 nm and 110 micron² at 1565 nm. It is to be noted that the effective area of the LP₀₂ mode at the representative wavelength λ₀ of 1550 nm is greater than the effective area of conventional SMTF at the same wavelength.

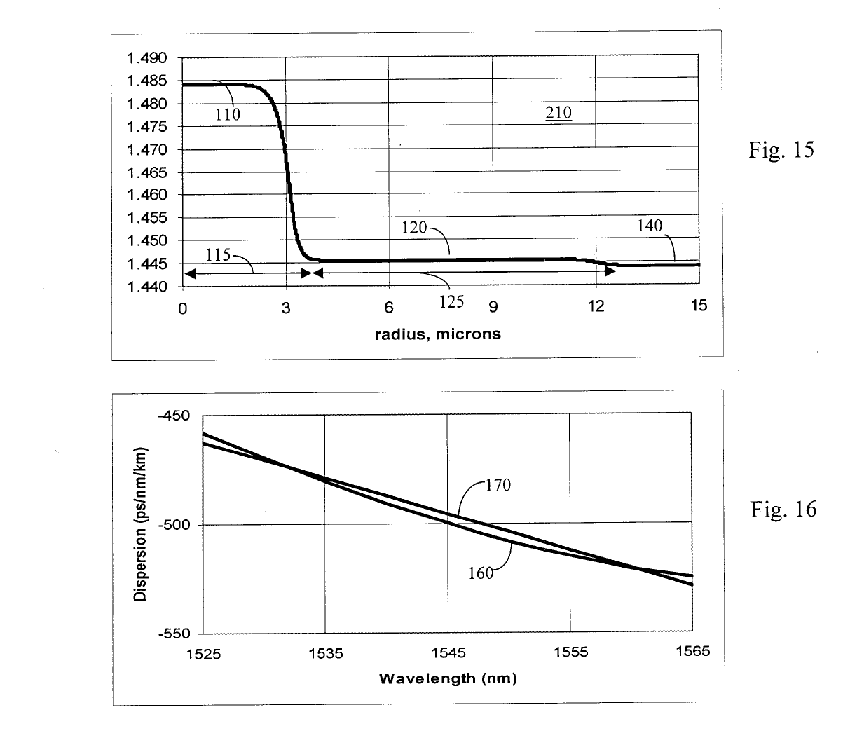

FIG. 15 illustrates a profile 210 of a fiber designed to have negative dispersion, a PZD of approximately 1247 nm a TOD of approximately 0.83% at a representative wavelength λ₀ of 1550 nm in accordance with a fifth embodiment of the subject invention. The PZD is designed to closely match the PZD of conventional SMTF and thus may be utilized without trim fiber 70. The x-axis represents fiber radius and the y-axis represents refractive index of the fiber at the operative wavelength of 1550 nm. Fiber profile 190 comprises first core area 110 exhibiting radius 115, adjacent second core area 120 exhibiting width 125 and adjacent cladding area 140. First core area 110 has a general shape wherein the refractive index varies over the radius 115 with a peak refractive index of 1.4840 corresponding to Δ₁ of 2.77%, and a radius of approximately 3.82 microns. Second core area 120 has a general shape exhibiting a lower refractive index of approximately 1.4456 corresponding to Δ₂ of 0.11%, with a width 125 of approximately 9.97 microns. Cladding area 140 extends the balance of the radius of the fiber as is known to those skilled in the art. In an exemplary embodiment total fiber radius is approximately 125 microns, however other fiber radii may be utilized without exceeding the scope of the invention. The profile exhibits a higher peak refractive index Δ₁, no depressed refractive index and only two zones as compared with profile 100 of FIG. 2.

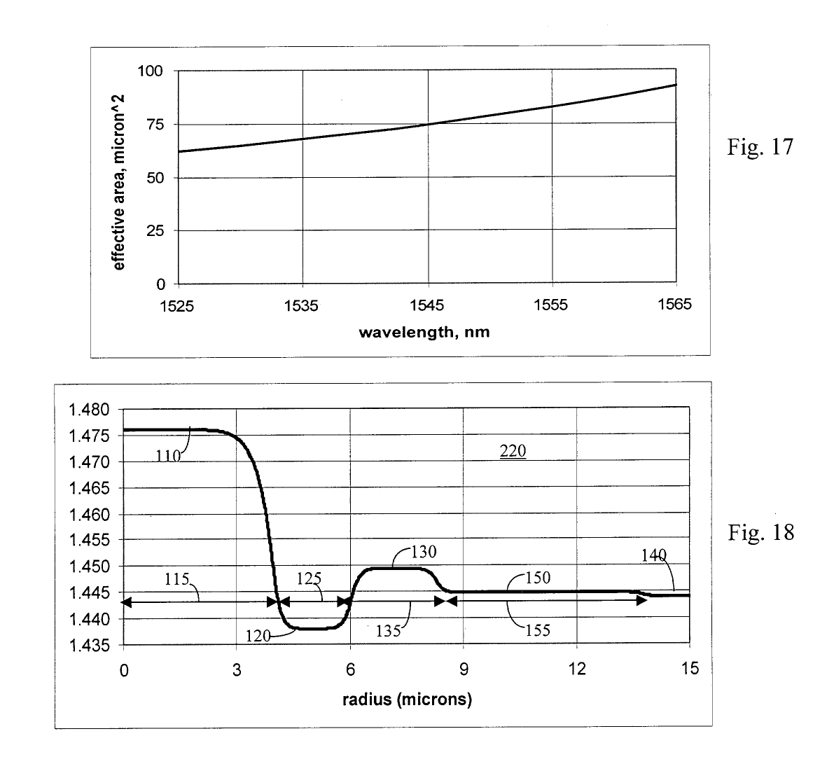

FIG. 16 illustrates plot 160 of the dispersion of the LP₀₂ mode for the few mode fiber profile 210 of FIG. 15 over the operative “C” waveband, and straight line 170 representing the best-fit line for dispersion plot 160, which is calculated to minimize the maximal difference between the best-fit line 170 and actual dispersion plot 160. The x-axis represents wavelength, and the y-axis represents dispersion in ps/nm/km. Plot 160 exhibits negative dispersion that is wavelength dependent, with dispersion at 1525 nm being approximately −458 ps/nm/km, dispersion at 1550 nm being approximately −508 ps/nm/km and dispersion at 1565 nm being approximately −525 ps/nm/km. Best-fit line 170 exhibits dispersion at λ₀ of 1550 nm of approximately −504 ps/nm/km and a slope of −1.7 ps/nm²/km, and a resultant PZD of 1247 nm. Such a PZD is advantageous for compensating for conventional SMTF without the use of trim fiber 70. The maximum difference between best fit line 170 and dispersion plot 160 is approximately 4 ps/nm and therefore the TOD is approximately 0.83%. FIG. 17 illustrates a plot of the effective area of profile 210 of FIG. 15 for the LP₀₂ mode, with the x-axis representing wavelength in nanometers and the y-axis representing effective area microns². The effective area is approximately 62 micron² at 1525 nm, 78 micron² at 1550 nm and 92 micron² at 1565 nm. It is to be noted that the effective area of the LP₀₂ mode at the representative wavelength λ₀ of 1550 nm is approximately the same as that of conventional SMTF at the same wavelength.

FIG. 18 illustrates a profile 220 of a fiber designed to have negative dispersion, a PZD of approximately 1426 nm and a TOD of approximately 1.5% at a representative wavelength λ₀ of 1590 nm in accordance with a sixth embodiment of the subject invention. The profile is optimized for compensation of a transmission fiber operating in the “L” band. The x-axis represents fiber radius and the y-axis represents refractive index of the fiber at the operative wavelength of 1550 nm. Fiber profile 220 comprises first core area 110 exhibiting radius 115, adjacent second core area 120 exhibiting width 125, adjacent third core area 130 exhibiting width 135, adjacent fourth core area 150 exhibiting width 155, and adjacent cladding area 140. First core area 110 has a general shape wherein the refractive index varies over the radius 115 with a peak refractive index of 1.4760 corresponding to Δ₁ of 2.22%, and a radius of approximately 4.07 microns. Second core area 120 has a general shape exhibiting a depressed index of approximately 1.4380 corresponding to Δ₂ of −0.42%, with a width 125 of approximately 2.00 microns. Third core area 130 exhibits a general shape with an increased refractive index of approximately 1.4495 corresponding to Δ₃ of 0.38%. Third core area 130 covers a width 135 of approximately 2.65 microns. Fourth core area 180 exhibits a general shape with an increased refractive index of approximately 1.4448 corresponding to Δ₄ of 0.06%. Fourth core area 180 covers a width 185 of approximately 5.55 microns. Cladding area 140 extends the balance of the radius of the fiber as is known to those skilled in the art. In an exemplary embodiment total fiber radius is approximately 125 microns, however other fiber radii may be utilized without exceeding the scope of the invention. Other advantages of profile 220 are described in co-pending U.S. patent application Ser. No. 10/298,548 filed Nov. 18, 2002 entitled “IMPROVED PROFILE FOR LIMITED MODE FIBER” whose contents are incorporated herein by reference.

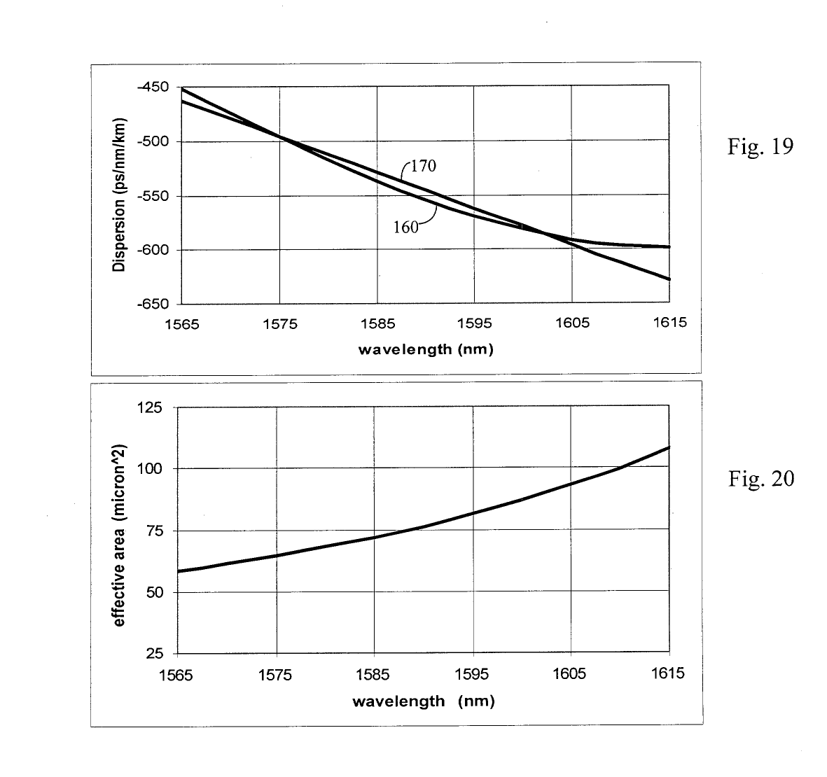

FIG. 19 illustrates plot 160 of the dispersion of the LP₀₂ mode for the few mode fiber profile 220 of FIG. 18 over the operative “L” waveband, and straight line 170 representing the best-fit line for dispersion plot 160, which is calculated to minimize the maximal difference between the best-fit line 170 and actual dispersion plot 160. The x-axis represents wavelength, and the y-axis represents dispersion in ps/nm/km. Plot 160 exhibits negative dispersion that is wavelength dependent, with dispersion at 1565 nm being approximately −452 ps/nm/km, dispersion at 1590 nm being approximately −554 ps/nm/km and dispersion at 1615 nm being approximately −599 ps/nm/km. Best-fit line 170 exhibits dispersion at λ₀ of 1590 nm of approximately −546 ps/nm/km and a slope of −3.3 ps/nm²/km with a resultant PZD of 1426 nm. Such a PZD is advantageous for compensating for certain low PZD NZDSF which exhibit a PZD of approximately 1410 nm. The maximum difference between best fit line 170 and dispersion plot 160 is approximately 1 ps/nm and therefore the TOD is approximately 0.2%.

FIG. 20 illustrates a plot of the effective area of profile 220 of FIG. 18 for the LP₀₂ mode over the operative “L” band, with the x-axis representing wavelength in nanometers and the y-axis representing effective area in microns². The effective area is approximately 58 micron² at 1565 nm, 76 micron² at 1590 nm and 108 micron² at 1615 nm.

It is appreciated that certain features of the invention, which are, for clarity, described in the context of separate embodiments, may also be provided in combination in a single embodiment. Conversely, various features of the invention that are, for brevity, described in the context of a single embodiment, may also be provided separately or in any suitable subcombination.

Unless otherwise defined, all technical and scientific terms used herein have the same meanings as are commonly understood by one of ordinary skill in the art to which this invention belongs. Although methods similar or equivalent to those described herein can be used in the practice or testing of the present invention, suitable methods are described herein.

All publications, patent applications, patents, and other references mentioned herein are incorporated by reference in their entirety. In case of conflict, the patent specification, including definitions, will prevail. In addition, the materials, methods, and examples are illustrative only and not intended to be limiting.

It will be appreciated by persons skilled in the art that the present invention is not limited to what has been particularly shown and described herein above. Rather the scope of the present invention is defined by the appended claims and includes both combinations and subcombinations of the various features described hereinabove as well as variations and modifications thereof which would occur to persons skilled in the art upon reading the foregoing description.

We claim:

1. A limited mode dispersion compensating optical fiber supporting at least one high order spatial mode comprising:
a plurality of core areas, the refractive index profile of which are selected to result in an optical waveguide providing in the LP₀₂ mode:
dispersion more negative than −300 ps/nm/km at a representative wavelength, designated λ₀, within an operative waveband;
projected zero dispersion less than (λ₀−75 nm), where projected zero dispersion is defined as λ₀−Dispersion (_{λ0})/Slope(_{λ0}); and
third order dispersion less than 2% over the operative waveband, where third order dispersion is defined as the maximum deviation from a best line fit for dispersion divided the best fit dispersion at λ₀, said best fit line chosen to minimize said maximum deviation.

2. The limited mode dispersion compensating optical fiber of claim 1 wherein the plurality of core segments further comprise:
a first core area having a peak refractive index nc₁;
a second core area contactingly surrounding said first core area having a peak refractive index nc₂;
a third core area contactingly surrounding said second core area having a peak refractive index nc₃; and
a cladding area surrounding said third core area having a refractive index n_{clad};
wherein said peak refractive index nc₁ is greater than nc₂, nc₃ and nc_{clad} and said peak refractive index nc₃ is greater than said nc_{clad}.

3. The limited mode dispersion compensating optical fiber of claim 2 wherein said peak refractive index nc₂ is less than said refractive index nc_{clad}.

4. The limited mode dispersion compensating optical fiber of claim 2 wherein the difference between said first core peak refractive index, nc₁, and said cladding area refractive index, nc_{clad}, divided by said nc_{clad} is less than about 2.8%.

5. The limited mode dispersion compensating optical fiber of claim 2 wherein the difference between said first core peak refractive index, nc₁, and said cladding area refractive index, nc_{clad}, divided by said nc_{clad} is less than about 2.2%.

6. The limited mode dispersion compensating optical fiber of claim 2 wherein the difference between said second core peak refractive index, nc₂, and said cladding area refractive index, nc_{clad}, divided by said nc_{clad} is more positive than about −0.42%.

7. The limited mode dispersion compensating optical fiber of claim 2 wherein the ratio of the difference between said first core area peak refractive index nc₁, and said cladding refractive index nc_{clad}, divided by said nc_{clad} is approximately 2.22% and said first cladding area exhibits a nominal radius of between 3.98 microns and 4.07 microns;
the ratio of the difference between said second core area peak refractive index nc₂, and said cladding refractive index nc_{clad}, divided by said nc_{clad} is between −0.37% and −0.42% and said second cladding area exhibits a nominal radial width of between 2.00 microns and 2.26 microns; and
the ratio of the difference between said third core area peak refractive index nc₃, and said cladding refractive index nc_{clad}, divided by said nc_{clad} is between 0.38% and 0.45% and said third cladding area exhibits a nominal radial width of between 2.34 and 2.65 microns.

8. The limited mode dispersion compensating optical fiber of claim 1 wherein said dispersion is more negative than −400 ps/nm/km at said representative wavelength.

9. The limited mode dispersion compensating optical fiber of claim 1 wherein said plurality of core areas further provides for an effective area in the LP₀₂ mode greater than 50 micron² at said representative wavelength.

10. The limited mode dispersion compensating optical fiber of claim 1 wherein said representative wavelength is 1550 nm.

11. The limited mode dispersion compensating optical fiber of claim 10 wherein said operative waveband comprises 1535 nm to 1555 nm.

12. The limited mode dispersion compensating optical fiber of claim 1 wherein said representative wavelength is 1590 nm.

13. The limited mode dispersion compensating optical fiber of claim 12 wherein said operative waveband comprises 1575 nm to 1605 nm.

14. An optical communication system comprising:
an optical transmission fiber exhibiting positive dispersion and positive dispersion slope;
a limited mode dispersion compensating optical fiber in optical serial communication with said optical transmission fiber, said limited mode dispersion compensating optical waveguide supporting the LP₀₂ mode; and
a mode transformer in optical communication with said limited mode dispersion compensating optical fiber;
wherein said limited mode dispersion compensating optical fiber exhibits a plurality of core areas, the refractive index profile of which are selected to result in an optical waveguide providing in the LP₀₂ mode:
dispersion more negative than −300 ps/nm/km at a representative wavelength, designated λ₀, within an operative waveband;
projected zero dispersion less than (λ₀−75 nm), where projected zero dispersion is defined as λ₀−Dispersion (_{λ0})/Slope(_{λ0}); and
third order dispersion less than 2% over the operative waveband, where third order dispersion is defined as the maximum deviation from a best line fit for dispersion divided the best fit dispersion at λ₀, said best fit line chosen to minimize said maximum deviation.

15. The optical communication system of claim 14 wherein said optical transmission fiber is a single mode fiber exhibiting zero dispersion at approximately 1330 nm.

16. The optical communication system of claim 14 wherein said optical transmission fiber is characterized by a projected zero dispersion between 1340 nm and 1420 nm.

17. The optical communication system of claim 14 wherein said optical transmission fiber is characterized by a projected zero dispersion between 1420 nm and 1475 nm.

18. The optical communication system of claim 14 wherein the plurality of core segments of said limited mode dispersion compensating optical fiber further comprise:
a first core area having a peak refractive index nc₁;
a second core area contactingly surrounding said first core area having a peak refractive index nc₂;
a third core area contactingly surrounding said second core area having a peak refractive index nc₃; and
a cladding area surrounding said third core area having a refractive index n_{clad};
wherein said peak refractive index nc is greater than nc₂, nc₃ and nc_{clad} and said peak refractive index nc₃ is greater than said nc_{clad}.

19. The optical communication system of claim 18 wherein the difference between said first core peak refractive index, nc₁, and said cladding area refractive index, nc_{clad}, divided by said nc_{clad} is less than about 2.8%.

20. The optical communication system of claim 18 wherein the difference between said second core peak refractive index, nc₂, and said cladding area refractive index, nc_{clad}, divided by said nc_{clad} is more positive than about −0.42%.
